(19) United States
(12) Patent Application Publication
(10) Pub. No.: US 2007/0135192 A1
(43) Pub. Date: Jun. 14, 2007

(54) Method and apparatus for providing a distributed gaming application

(76) Inventor: George Bruce McLaren, London (GB)

Correspondence Address: PARK, VAUGHAN & FLEMING LLP, 2820 FIFTH STREET, DAVIS, CA, 95618-7759, US

(21) Appl. No.: 11/303,069

(22) Filed: Dec. 13, 2005

(51) Int. Cl. G06F 19/00

(52) U.S. Cl. 463/11

(57) ABSTRACT

A method and apparatus are provided to control a game involving a group of players. The game involves associating each player with a game card comprising a set of values. Each player is then provided with a sequence of position options. A position option comprises at least first and second identifiers for values from the game card. A player on receiving the first identifier chooses whether or not to accept the corresponding value from the player's game card. The player is allocated the value corresponding to the first identifier if this value has been accepted by the player; otherwise the player is allocated the value corresponding to the second identifier.

### FIELD OF THE INVENTION

The present invention relates to the provision of a gaming application, for example over the Internet.

### BACKGROUND OF THE INVENTION

Over the past few years there has been a rapid increase in distributed, interactive applications provided over networks such as the Internet, mobile telephone networks, digital television, and so on. One very popular on-line application is poker. The company Partygaming, which operates the world's largest on-line poker site, was floated this summer on the London stock exchange with a market value of several billion pounds.

One limitation in the growth of poker applications is that the game is relatively complex. Although this makes poker attractive to certain players, there are many others who do not participate in the game simply because they do not understand the rules. In addition, a conventional poker game normally involves only a handful of players. This makes it difficult to offer large prize money game, unless each individual player risks a substantial sum of money. Furthermore, poker generally requires relatively extensive graphics to depict all the different cards. However, some small mobile devices may only have limited graphics capabilities, e.g. no colour support, and/or a very limited screen size, thereby restricting the range of suitable client devices that are appropriate for conventional poker games.

### SUMMARY OF THE INVENTION

One embodiment of the invention provides a method controlling a game involving a group of players. The method comprises associating each player with a game card comprising a set of values. Each player is then provided with a sequence of position options, a position option comprising at least first and second identifiers for values from the game card. On receiving the first identifier, a player chooses whether or not to accept the value corresponding to the first identifier from the player's game card. If accepted by the player, this value is allocated to the player's game card; otherwise the value corresponding to the second identifier is allocated to the player.

In one particular embodiment, each game card comprises a grid of boxes, for example a five by five grid (although other sizes and/or shapes or configurations could be used instead). The twenty-five boxes of the grid are filled by four instances of each of six different values, plus a wild card. The different values may correspond to coins, since these have a readily understood order and can be easily customised to different countries, although numbers, letters or some other symbols might be used instead. The sequence of position options comprises five pairs of first and second identifiers which then produces a resulting player hand from the game card of five values—i.e. one value per pair. The different hands of the various players participating in the game can then be compared based on the ranking of poker hands (e.g. four of a kind beats a full house, which beats a three of a kind, etc). In general the server retains a record for each player of the associated game card and sequence of position pairs so that the server can determine the winning hand automatically.

A player is not aware of the value of the game card corresponding to the second identifier when choosing whether or not to accept the first identifier. Thus a player can use skill and judgement to determine whether accepting or rejecting the first identifier is most likely to benefit his/her hand, based on the contents of his/her hand so far and the exposed positions on the game card.

Another embodiment provides a computer program product comprising program instructions that when executed implement a method such as described above for operating a server to control a game involving a group of players. Note that the computer program product may be provided as a set of instructions recorded onto a physical medium, such as a CD, a DVD, and so on, or encoded into a transmission medium on a wireless or wired network such as the Internet. In either case, such instructions can then be loaded onto one or more computer or other electronic systems for execution. In other cases, the program instructions may be preinstalled onto the appropriate server and/or client devices.

Another embodiment provides apparatus operable to control a game involving a group of players. The apparatus includes a game card for each player, each game card comprising a set of values, and a display or communications interface for providing each player with a sequence of position options comprising at least first and second identifiers for values from said game card. A player on receiving the first identifier is therefore able to choose whether or not to accept the corresponding value from the player's game card. The apparatus further includes a storage facility to record the allocation to the player of the value corresponding to the first identifier if accepted by the player, and otherwise to record the allocation to the player of the value corresponding to the second identifier.

### BRIEF DESCRIPTION OF THE DRAWINGS

Various preferred embodiments of the invention will now be described in detail by way of example only with reference to the following drawings:

FIG. 1 is a schematic diagram of a client-server network;

FIG. 2 shows the clients from the network of FIG. 1 arranged into groups;

FIG. 3 is a high-level flowchart showing processing in accordance with one embodiment of the invention; and

FIG. 4 is a further flowchart showing in more detail the operation of playing a game from FIG. 3.

### DETAILED DESCRIPTION

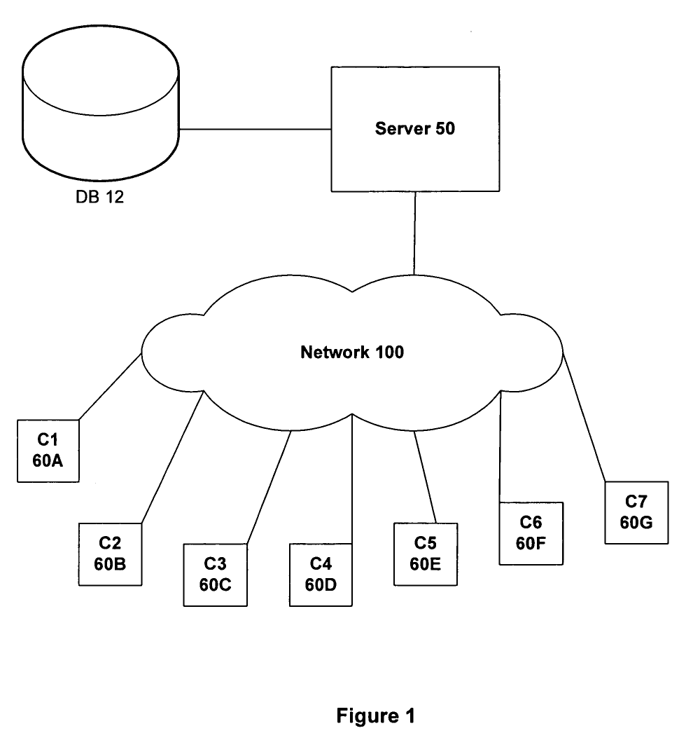

FIG. 1 is a diagram of a distributed system in accordance with one embodiment on the invention. The system includes a server 50 which is linked to a database 12. The server is further linked to a plurality of clients 60A, 60B, 60C, 60D, 60E, 60F, 60G by network 100. Network 100 may represent a computer network, such as the Internet, a mobile telephone network, a digital television network, or any other appropriate wired and/or wireless data communications facility.

Server 50 may be linked to the network 100 via any suitable device. For example, if network 100 represents the Internet, then a web server (not shown in FIG. 1) may be interposed as required between server 50 and network 100. Likewise, if network 100 comprises a mobile telephone network, then server 50 may communicate with clients 60 via the network 100 using appropriate transmission and reception facilities.

Server 50 may be implemented with any suitable computer or combination of computers. Clients 60 may likewise be implemented using any suitable device with network connectivity and some graphical display facility, for example a personal computer, a laptop, a personal digital assistant (PDA), a workstation, a digital television set, a mobile (cellular) telephone, and so on. The clients may be pre-configured with appropriate software, or may download the appropriate software from the network 100, whether from server 50 or some other system. In some embodiments, server 50 may provide clients 60 with a Java applet or similar form of network program (Java is a trademark of Sun Microsystems Inc). Note that while FIG. 1 depicts seven clients linked to server 50, the number of clients so connected may be much higher—potentially hundreds, thousands, or even more.

A variety of clients 60 may be connected to server 50 over one or more different types of network. For example, clients C1, C2, C5 and C6 may be mobile telephones linked to server 50 over a mobile telephone network; clients C3 and C4 may be computer workstations linked to server 50 via the Internet; and client C7 may be a digital television set linked to server 50 via television broadcast (for downstream from server 50 to client C7) and via a telephone network (for upstream from client C7 to server 50).

In one particular implementation, the server 50 and clients 60 may be located in a casino or other such establishment. In this implementation, the clients 60 may comprise slot machines or similar that are linked to a central control system 50 via a bus (e.g. USB), a local area network, or any other suitable data communications facility.

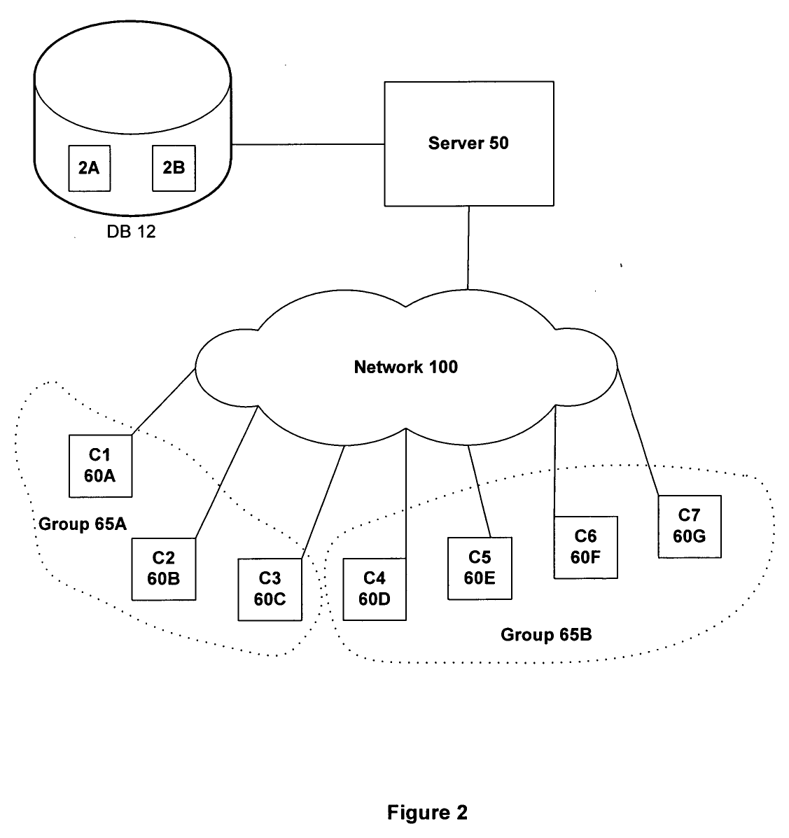

FIG. 2 illustrates the distributed system of FIG. 1 configured for a game in accordance with one embodiment of the invention. In this game, the clients 60 are allocated to one or more groupings. The clients within any given grouping are playing against each other for at least the next round of the game. Thus in the example shown in FIG. 2, clients C1, C2, and C3 form a first grouping to play against one another, while clients C4, C5, C6 and C7 form a second grouping to play against one another.

FIG. 2 also shows that database 12 is used to store game cards 2A, 2B, etc. Note that for clarity, database 12 is shown as only containing two game cards, but the number of stored game cards 2 in database 12 may be much higher, running into thousands, millions, or even more. In other embodiments, database 12 may be omitted. In such embodiments, server 50 may generate game cards as and when needed. Alternatively, the game cards may be stored and/or generated on the clients 60 themselves.

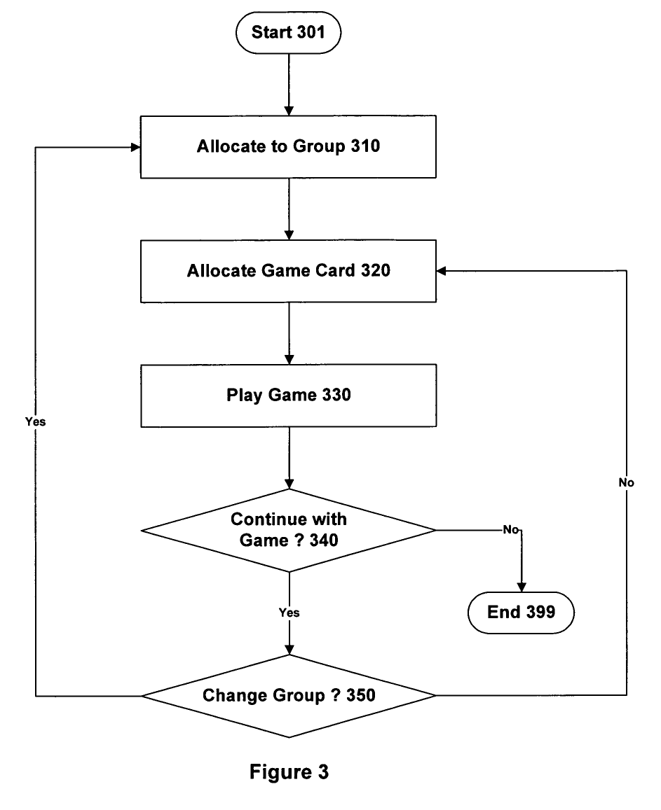

FIG. 3 is a flowchart depicting high-level operations in accordance with one embodiment of the invention. The method commences at start operation 301. This may involve a new player registering with server 50 and providing some form of account information to fund involvement in the game. Such charging might be accomplished using credit card information, or by directing charges to a telephone or television account. The new player may also have to confirm at registration that they are of sufficient age to participate in the game. The skilled person will be aware of various possible approaches for handling registration and account management.

Assuming that a player is entitled to participate in a game, the new player is then allocated to a group (310), such as shown in FIG. 2, and is also allocated a game card (320). It will be appreciated that in some embodiments, the allocation of a game card to a user (320) may be performed prior to the allocation of a user to a group (310)—i.e. the reverse of the order shown in FIG. 3.

In some embodiments, the server may (at a given time) only support a single group of players, in which case a new player is allocated automatically to that group. For example, all the current players in a casino implementation may represent a single group. However, if the server is running multiple groups, there are various possible mechanisms whereby a new player might be allocated to a particular group. In some embodiments, the allocation of a player to a group may be performed partly or entirely based on a request of a user. For example, a player may want to select a specific group based on one or more of the following criteria:

(a) joining the same group as one or more known other players.

(b) avoiding the same group as one or more known other players;

(c) group size—the larger a group the less the chance of any given player winning, but usually the greater the prize fund for the player who does win;

(d) the stake size being used for a given group; and

(e) the particular variant of game format being played by a given group.

(The skilled person will be aware of other potential criteria for the user selection).

Regarding options (a) and (b) above, it will be appreciated that some systems may make available a listing of players that are currently participating within the various games (either in terms of their user name and/or real name). Alternatively, the system may not identify group members at the group allocation stage, but only later provide information to a player about the other members of the group to which they are allocated. In other implementations, the system may withhold from players information about group membership altogether.

In some embodiments, the allocation of a player to a group may be performed partly or entirely by the server 50. For example, in some embodiments, a player might provide information about one or more of the criteria set out above in the form of preferences. These preferences may then be stored, either in server 50 (e.g. in database 12), or on the relevant client 60 (e.g. in the form of a cookie). The server can then try to allocate a player to a game in accordance with these user preferences.

The server may also collect other information about a player for use in game allocation. For example, the server may track the experience level or success of a given player and use this for game allocation. The server might also allocate a user to a group (at least in part) on a random basis, and/or using additional information such as the geographical location or type of network connection to the user (Internet, mobile telephone, etc).

Considering now the allocation of a game card to a user (320), Table 1 represents an example of a game card in accordance with one embodiment of the invention. Such a game card can be displayed to a player on a client device 60.

TABLE 1

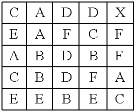

In this particular embodiment, the game card comprises a 5×5 grid. Each box in the grid is assigned a value, denoted by one of the letters A-F and X. In particular, each of letters A-F occurs 4 times in the grid, while the letter X occurs only once. In this embodiment, the letter X then corresponds to a wild card; in other words, the value X can be chosen by the user to represent any of the other desired values A-F. The total number of possible cards having the format shown in Table 1 is given by 25×(24!)/(4!)⁶≈10¹⁷. Hence the chance of two users having the same game card is extremely small, assuming that the game cards are allocated at random.

In one embodiment, each of the values A-F corresponds to a particular coin. For example, with UK coinage, the following allocation might be made: A=1p, B=2p, C=5p, D=10p, E=20p, F=50p. It will be appreciated that such an allocation provides an implicit ordering of the values (F>E>D>C>B>A) that can be readily understood by a player.

There are various mechanisms whereby a game card can be allocated to a player. In one embodiment, database 12 stores a set of game cards 2A, 2B (see FIG. 2), and one of these is allocated to a new user. For example, the different game cards in database 12 might be ordered into some sequence, and each new user is assigned the next game card in the sequence. Alternatively, a user may be able to select a desired game card from those available within database 12. In other embodiments, database 12 may be omitted, and server 12 generates new game cards on a random basis as required for each new player. A further possibility is that client device 60 is used to store or to generate a game card for the player using that device.

After a player has joined a group and has been allocated a game card, he/she is then able to participate in a hand or round of the game (330). After the hand is completed, the player may decide to continue with the next hand of the game (340) or to quit (399). In some implementations, the player may be given the opportunity to change group prior to the next hand (350). There may also be an option for the player to retain a game card into the next round if so desired. (Note that although reference is made to different hands or rounds of the game, it will become apparent that each hand or round is in effect an independent performance of the game).

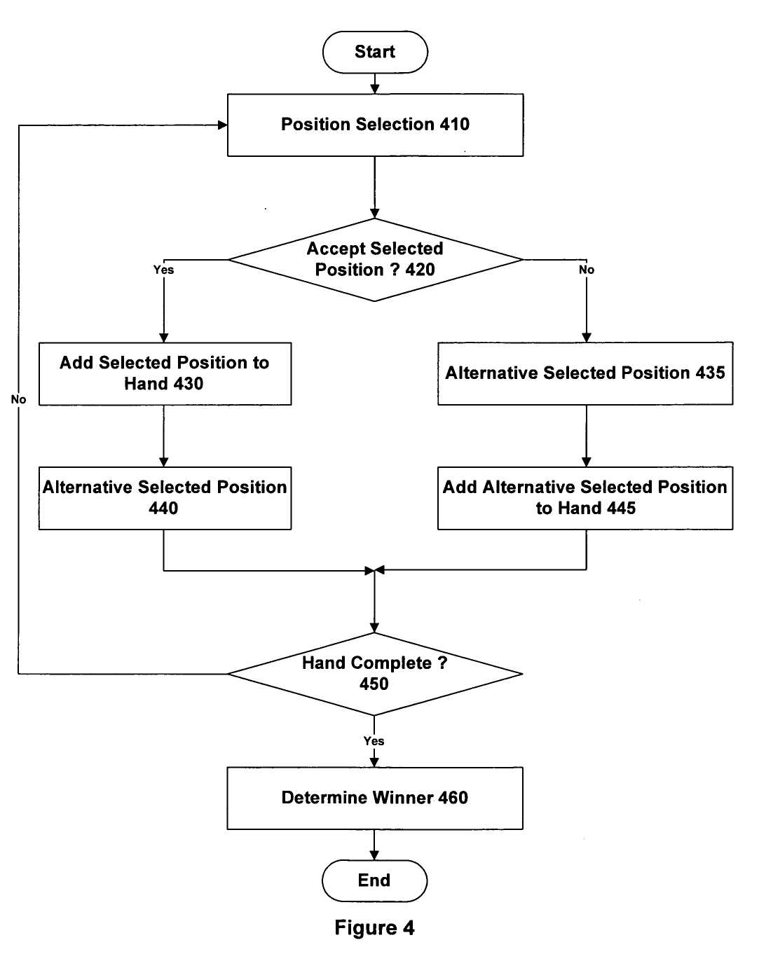

FIG. 4 is a flowchart illustrating in more detail the playing of a game in accordance with one embodiment of the invention (i.e. corresponding to operation 330 from FIG. 3). The method starts by providing a first position selection to a user that specifies one of the boxes in the game card (410). For example, let us assume that the position selection is row 2, column 5 (r2c5). This may be indicated on the client device 60 to the player as shown in Table 1A, where the value corresponding to the selected position is underlined. (It will be appreciated that any other appropriate form of highlighting could be used instead of underlining, such as a different colour, size, intensity, flashing, etc).

TABLE 1A

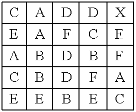

The user now has to decide whether or not to accept this positional selection (420). For present purposes, we will assume that the user does accept the position (with the mapping described earlier, the letter F corresponds to 50p, the highest possible value). Accordingly, the letter F is added to the user hand (430). We can denote the hand so far as [F, -, -, -, -], where the dashes correspond to selections still to be made.

An alternative position is now generated (440). We assume that this alternative position corresponds to r3c1 (A). Since the user selected the first position at operation 420, this alternative position is not directly relevant to the user, except that it is now known that the position of r3c1 is not available for subsequent selection. In other words, if the user accepts the position selection from operation 410, then the alternative position selection from operation 440 can be considered as automatically rejected. This leaves us with the position shown in Table 1 B, where r2c5 is shown in bold, to indicate that it is part of the user's hand, while r3c1 is shown in italic, to show that it has already been selected as a position, but has not been accepted into the user's hand.

TABLE 1B

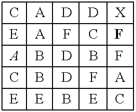

We now proceed to operation 450, where since the hand is not complete, we return to receive another position selection (410). Let us assume that this new position selection is r5c3, and that the user decides to reject this selection at operation 420 (it is a relatively low-value selection, B). An alternative position is now selected (435), for example rlc3 (D), and this is automatically added to the user's hand (445). The user's hand therefore now comprises [F, D, -, -, -], and the grid appears as shown in Table 1C.

TABLE 1C

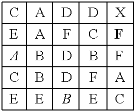

Processing then continues as above until the user's hand has been completed with 5 values. It will be appreciated that for each addition to the user's hand, a pair of positions is generated. The user gets to see a first position from this pair, and has the choice of either accepting or rejecting the first position (prior to seeing the second pair of the position). If the user accepts the first position, then the second position of the pair is, in effect, automatically rejected; conversely, if the user rejects the first position, then the second position of the pair is, in effect, automatically selected.

If we assume that the final three position pairs to complete the hand in the above example are: (r5c1(accepted), r4c1); (r2c1(accepted), r4, c2); and (r4c3 (rejected), r3c2), this produces a final hand of [F, D, E, E, B], and leads to the position shown in Table 1D.

TABLE 1D

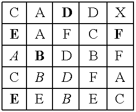

Once the hands of all the players in a group have been completed, they can be compared with one another in order to determine a winner (460). For this comparison, the hands can be ranked in an order based on conventional poker, e.g. in the following order (highest value first, lowest value last):

a) five of a kind (using wild card)

b) four of a kind

c) full house (a triplet and a pair)

d) straight (A, B, C, D and E; or B, C, D, E and F)

e) three of a kind

f) two pairs

g) pair (two of a kind).

If two or more hands both have N of a kind (N=2, 3, 4 or 5), then the hand with the highest value for the N of a kind wins—e.g. three F's beats three B's (assuming as above that F=50p and B=2p). Other ranking, e.g. of two pairs, a full house etc can follow conventional poker rules.

It will be appreciated that choosing whether to accept or reject the initial card of each pair introduces an element of skill into the game. In particular, the choice can be based on awareness of the desired target hand (e.g. whether aiming for multiple cards of the same value or for a straight), as well as of the box values that have already been rejected (and hence cannot become part of the hand in the future).

The user interface for the game may vary from one embodiment to another. For example, in one implementation, the game card values are blanked out except when a position selection arrives, which causes the relevant position on the game card to open, thereby exposing the underlying value for this position to the user. Once the user has determined whether to accept or reject this value, the value is now obscured again, and the value for the second position in the pair is exposed in turn. In this implementation, positions that have been accepted are marked with one symbol (e.g. a O), while positions that have been rejected are marked with another symbol (e.g. an X). The values accepted into the hand so far are then presented beneath the grid. For example, in such an embodiment, the situation of Table 1C would appear as shown in Table 1E below:

TABLE 1E

| | | |
|---|---|---|
| | O | |
| | | O |
| X | | |
| | X | |

[F,D,-,-,-]

Note that in one implementation, the system may automatically arrange the hand contents into value order (rather than presenting them in the order in which they were selected by the user). Such rearrangement is illustrated in Table 1F below, which corresponds to the situation of Table 1D above.

TABLE 1F

| | | | |
|---|---|---|---|
| | | O | |
| O | | | O |
| X | O | | |
| X | X | X | |
| O | | X | |

[F,E,E,D,B]

It will be appreciated that the game is based on two elements, a game card having a distribution of values and a sequence of positions. In general both of these two elements will be controlled by the server and be random, although it is possible for one element (at most) to be determined on a non-random basis. For example, if the sequence of positions is to be chosen randomly, then users might be allowed to select or design their own game cards (providing that such game cards conform to the relevant format, such as having the appropriate number of each value). Alternatively, if the game cards are randomly allocated, then the sequence of positions might be user-determined. For example, in a casino implementation, a user might select particular boxes in the game card. It will be appreciated that with this latter approach, the remaining values on the game card must be concealed or withheld from a user prior to the user making his or her position selections.

Different players within the same group may be provided with the same or with different position sequences. The latter option increases variation within the game, while the former option is more straightforward for the server to administer (the server does not need to generate separate position pairs for each player).

Server 50 may control the timing of the game to ensure appropriate synchronisation between the different players. For example, the server may communicate the first position of a position pair to all players in the group at substantially the same time. The players can then be provided with a fixed time period in which to accept or reject this position (the client may support some form of numerical or graphical device to indicate the amount of remaining time). The game may be provided with a default option which is automatically effective in the absence of any positive response from a player. For example, if the user does not accept the first position within the set time period, the player might be deemed automatically to have rejected this first position. The user response (or lack of one) can then be communicated back from the client to the server. When the server has collected all the client responses, the second position in the pair may now be distributed to the clients, and so on for subsequent pairs.

In general, it is not expected that the players are able to access information about the current hands of other players in their group. Although some embodiments may provide such a facility, this is likely to be impracticable, especially if the number of players is large or if the client devices have only restricted functionality (e.g. mobile telephones with small screens). Another possibility is to offer players limited information about the current hands in the group—for example, merely notifying the participants of the contents of the hand that is currently winning (prior to selection of a full hand). It will be appreciated that such information about the hands of other players, if available, may influence how a player handles a particular position option.

In some implementations, the game may be played simply for fun, without any prize money being available. In this case, the operation of the server, etc might be funded by advertising or sponsorship. In other implementations, such advertising or sponsorship may also be used to provide some form of prize to the winner, without there being any financial input from the participants themselves. More normally however, it is expected that the players will pay to participate in a game, either per game (or session of games) or on a subscription basis.

In some implementations there may be a fixed cost (C) to participate in the game. For example, in a casino implementation, the players may insert a coin into a slot machine to participate in the next game. If there are N participants in the game, then the prize money to the winner may be set at f.C.N, where f is some appropriate fraction (say 80%). In the event of a tie, where two or more players have hands of identical value, this prize money may be shared between the joint winners. The skilled person will be aware of other possible distributions of the available prize money, for example two-thirds to the winner, and one-third to the second place player.

Other implementations may support more complex stake arrangements, say for example allowing a player to increase his or her stake after each new value is added to their hand (depending on how confident they feel). In this case the stake could be regarded more as a bet on the outcome, and the server can provide odds associated with any increased stake as appropriate.

It will be appreciated that server 50 generally tracks both the game card and the position sequence for each player. Thus even if a player opts to use a game card already installed on client device 60 for a game, this will generally be communicated to the server prior to commencement of the game.

In one embodiment, a further competition is run in parallel with the main poker-based game. This is based on the pattern of selections for a user on a given game card—either in respect of just those selections accepted by the user, or else all selections received (whether selected or rejected). If the pattern of selections for a user matches a predetermined pattern (which may be displayed to the users), then the user may be entitled to a jackpot prize.

For the implementation discussed above, with a five by five game card and ten received positions (five sets of position pairs), there are over 3 million possible configurations of the selected positions (ignoring the values associated with the selected positions). The likelihood of a jackpot match for any given game card and hand is therefore very small, but conversely, the prize for making such a match might be made or become relatively large. The jackpot prize might be funded, for example, by taking a small slice of the stake on each individual game.

Although a range of embodiments has been described above, the skilled person will be aware of many further possible variations. For example, other embodiments may adopt a different shape or size for the game card—not necessarily a grid, and/or not necessarily twenty-five positions, and/or not necessarily four groups of six different values or a wildcard, and so on. The number of position options provided to the user may also vary, as might the nature of a position option itself—e.g. the user might be provided with first and second identifiers, and asked to reject one of these for replacement by a third identifier. It will be appreciated that such parameters can be varied to alter the duration of a game, the number of possible final hands, complexity of the user selection, the likelihood of a tie, and so on. In addition, the game card values may not denote coins, but rather any suitable set of values, such as symbols, numbers, colours, etc, may be used instead (coins have the advantage of being readily ordered by numerical value, easy and attractive to represent visually, and also straightforward to customise to different geographies).

Furthermore, although the embodiments described above have been implemented over some form of electronic or electrical network, such as a computer, telephone, or television network, the game could also be provided locally. For example, in a very simple version, players could design their own game cards on paper, and use one or more dice, a spinning wheel, or such-like to generate the sequence of position options. In other versions, some form of electronic device might be used to generate the sequence of position options and/or game cards. Thus each player might receive an electronic device which generates a game card for them (or allows them to select a stored game card or to enter their own desired game card). The sequence of position pairs might then be generated with the same electronic device, by some shared device common to all players, or selected and entered by the individual players.

In conclusion, a variety of particular embodiments has been described in detail herein, but it will be appreciated that this is by way of exemplification only. The skilled person will be aware of many further potential modifications and adaptations that fall within the scope of the claims and their equivalents.

1. A method of controlling a game involving a group of players, the method comprising:
associating each player with a game card comprising a set of values;
providing each player with a sequence of position options, a position option comprising at least first and second identifiers for values from said game card, wherein a player on receiving the first identifier chooses whether or not to accept the corresponding value from the player's game card; and
allocating to the player the value corresponding to the first identifier if accepted by the player, and otherwise allocating to the player the value corresponding to the second identifier.

2. The method of claim 1, wherein each game card comprises a grid of boxes.

3. The method of claim 2, wherein each game card comprises a five by five grid of boxes.

4. The method of claim 3, wherein the twenty-five boxes of the grid are filled by four instances of each of six different values, plus a wild card.

5. The method of claim 4, wherein the sequence of position options comprises five pairs of first and second identifiers.

6. The method of claim 1, wherein the values in the game card correspond to different coins.

7. The method of claim 1, wherein after the sequence of position options has been fully provided, the values allocated to the player are compared with values allocated to other players to determine one or more winning players.

8. The method of claim 7, wherein the comparison of values for one player against another player is based on ranking of poker hands.

9. The method of claim 1, wherein said associating comprises the server randomly generating a game card for a player.

10. The method of claim 1, wherein said providing comprises the server randomly generating the sequence of position options for a player.

11. The method of claim 1, further comprising retaining a record for each player of the associated game card and sequence of position options.

12. Apparatus operable to control a game involving a group of players, the apparatus including:
a game card for each player, each game card comprising a set of values;
a communications interface or display for providing each player with a sequence of position options, a position option comprising at least first and second identifiers for values from said game card, thereby allowing a player on receiving the first identifier to choose whether or not to accept the corresponding value from the player's game card; and
a storage facility for recording the allocation to the player of the value corresponding to the first identifier if accepted by the player, and otherwise the allocation to the player of the value corresponding to the second identifier.

13. The apparatus of claim 12, wherein each game card comprises a five by five grid of boxes.

14. The apparatus of claim 13, wherein the twenty-five boxes of the grid are filled by four instances of each of six different values, plus a wild card.

15. The apparatus of claim 13, wherein the sequence of position options comprises five pairs of first and second identifiers.

16. The apparatus of claim 12, wherein the values in the game card correspond to different coins.

17. The apparatus of claim 12, wherein the apparatus is operable to randomly generate game cards for the players.

18. A computer program product comprising program instructions that when executed implement a method of controlling a game involving a group of players, the method comprising:
associating each player with a game card comprising a set of values;
providing each player with a sequence of position options, a position option comprising at least first and second identifiers for values from said game card, wherein a player on receiving the first identifier chooses whether or not to accept the corresponding value from the player's game card; and
allocating to the player the value corresponding to the first identifier if accepted by the player, and otherwise allocating to the player the value corresponding to the second identifier.

19. A method of operating a client to participate in a game comprising:
presenting a game card comprising a set of values for a player using the client;
receiving a sequence of position options, a position option comprising at least first and second identifiers for values from said game card, wherein the player on receiving the first identifier chooses whether or not to accept the corresponding value from the player's game card; and
allocating to the player the value corresponding to the first identifier if accepted by the player, and otherwise allocating to the player the value corresponding to the second identifier.
